(19) United States
(12) Patent Application Publication
(10) Pub. No.: US 2002/0047819 A1
(43) Pub. Date: Apr. 25, 2002

(54) Liquid crystal display element and liquid crystal display apparatus

(75) Inventors: Noriko Suehiro, Yokohama-shi (JP); Satoshi Niiyama, Yokohama-shi (JP); Masao Ozeki, Yokohama-shi (JP); Kazuhiro Monzen, Amagasaki (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: OPTREX CORPORATION, Tokyo (JP)

(21) Appl. No.: 09/813,988

(22) Filed: Mar. 22, 2001

(30) Foreign Application Priority Data
Mar. 23, 2000 (JP) 2000-081622
Apr. 20, 2000 (JP) 2000-118942
Nov. 1, 2000 (JP) 2000-335267

(51) Int. Cl. G09G 3/36

(52) U.S. Cl. 345/87

(57) ABSTRACT

In a liquid crystal display element provided with a liquid crystal layer having a memory function, 4.0≦a≦d·V/10 is satisfied where a represents a space (an interline width) between transparent electrodes 31, 31 adjacent to each other on the same surface of a substrate 3, d (μm) represents the thickness of the liquid crystal layer interposed between the transparent electrodes 21, 31 (a pixel portion D) opposing between upper and lower substrates 2, 3, V_{MAX} represents the maximum effective voltage required to change a display, and a (μm) represents the maximum space of the transparent electrodes whereby a uniform alignment state in a pixel portion and an interline portion can be obtained.

### CROSS-REFERENCE TO RELATED APPLICATIONS

The entire disclosure of Japanese Patent Application No. 2000-81622 filed on Mar. 23, 2000, No. 2000-118942 filed on Apr. 20, 2000 and No. 2000-335267 filed on Nov. 1, 2000, including specification, claims, drawings and summary are incorporated herein by reference in its entirety.

### BACKGROUND OF THE INVENTION

1. Field of the Invention

The present invention relates to a liquid crystal display element provided with a liquid crystal layer having a memory function and a liquid crystal display apparatus using the same.

2. Description of the Background

At present, TN, STN or TFT liquid crystal display elements are widely used. These liquid crystal display elements effect a display by conducting predetermined driving at all times. On the other hand, antiferroelectric liquid crystal display elements having a memory function of operation (hereinbelow, referred to as AF-LCD) and cholesteric or chiral nematic liquid crystal display elements (hereinbelow, referred to as CL-LCD) are noted, and practical applications thereof are studied.

The principle of operation of AF-LCD is described in Proc. Japan Display 1989, 26 (1989). In the basic operation, the liquid crystal layer in a ferroelectric state can provide a first bookshelf state (+F) and a second bookshelf state (−F) depending on polarities of a voltage applied from the outside. Then, a stable transfer can be effected among the both states and an antiferroelectric state by applying voltages, whereby displays according to the three states can be obtained.

A structure that a black display is effected in an antiferroelectric state and a white display is effected in two ferroelectric states (+F or −F) in combination with a pair of polarizers, is made. In AF-LCD, when the liquid crystal cell is formed, it is essential that liquid crystal is aligned uniformly in the entire of the display surface. Usually, a current feeding treatment is conducted by applying to a liquid crystal layer a high voltage for about several seconds in order to arrange the liquid crystal layer in order.

The principle of operation of CL-LCD is described in U.S. Pat. No. 3,936,815 and U.S. Pat. No. 4,097,127. Basically, it is stable at least in two states: a planar state wherein a part of incident light is selectively reflected (hereinbelow, referred to as a PL state) and a focalconic state wherein incident light is scattered (hereinbelow, referred to as a FC state), and the transfer can be effected between these states. FIG. 1 shows the structure in cross section of the element as an example. A display is effected without using polarizers.

In CL-LCD, a display state can be maintained even when the power source is interrupted after a voltage has once been applied to render the device to be in such display state. In AF-LCD, a display state can be maintained as well although it is necessary to apply a holding voltage.

In order to transfer a maintained display state to another display state in CL-LCD, a predetermined voltage should be applied again. In this case, it is preferable that a voltage necessary for the next display is applied after the entire area of the display surface has once been erased.

Namely, it is preferred from the viewpoint of use to ease completely a display which has already been displayed, and then, to rewrite a new display. Usually, the liquid crystal display element is made in a state of exhibiting a background color (a dark color such as black) by rendering the entirety of the display surface to be a FC state. Then, a display is generally effected by drawing a line picture of a clear brightness level by making desired pixels to be in a PL state.

However, a display state is sometimes changed from a FC state to a PL state by the application of an external force. For example, such change takes place when other object or the users hand contacts directly the display surface of CL-LCD. Or, besides the users hand directly contacts the display surface during use, there is a possibility that an external force is applied to the display surface when the liquid crystal display element is assembled into a display apparatus.

In a liquid crystal region interposed directly between row electrodes (X electrodes) and column electrodes (Y electrodes) arranged to oppose, the contents of display changed by an external force can be restored by applying again a predetermined voltage. However, in the liquid crystal region positioned at an interline portion to which a voltage can not directly be applied, the state of alignment can not be controlled as desired.

Accordingly, if the interline portion is changed to a PL state (a reflective state in operation) by an external force, there is a problem that it is difficult to restore a change of display in an interline portion. Namely, even when writing is conducted again to restore the display state in a liquid crystal region interposed between electrodes, an interline portion still maintains a reflective state, and accordingly, the contrast ratio of display decreases largely.

Further, there is the same problem in a case that a segment display is effected in a negative display mode in which a light display is provided in a dark background portion. When an interline portion becomes a PL state by an external force, the interline portion keeps a reflective state even though writing is conducted again. Accordingly, a portion which should be black in display is in a reflective state along the edge of display electrodes, and therefore, it is difficult to observe an intended display.

FIG. 5 shows such display state. FIG. 5(A) shows that in a display of “6”, there is disorder in the alignment of liquid crystal in a right upper segment portion by the application of an external force. Even in a case that writing was conducted to display “6” again after the application of an external force has been removed, there remains a display as shown in FIG. 5(B) wherein a colored fringe of the segment is observed. A hexagonal fringe portion corresponds to “an interline portion” in the absence of electrodes, and the alignment of the liquid crystal region is disordered.

Next, explanation will be made as to AF-LCD. FIG. 6 shows the structure in cross section of AF-LCD 50. It comprises a front side polarizer 9, a front side substrate 3, an interlayer 8, a front side electrode 31, a liquid crystal layer 5, a peripheral seal 4, a rear side electrode 21, a rear side substrate 2 and a rear side polarizer 7. FIG. 7 is a graph showing the relation of an applied electric field and transmitting light intensity in AF-LCD wherein three alignment states of the liquid crystal layer are shown.

In the AF-LCD, it is essential to conduct an in-plane aligning treatment to the liquid crystal cell. Further, even after the aligning treatment has been conducted, the disorder of alignment may be caused due to an external factor such as the application of an external force, a temperature change and so on. In re-aligning liquid crystal by a current feeding treatment, the element structure capable of aligning stably and uniformly the liquid crystal, is needed.

As described above, although there are peculiar problems in the memory type liquid crystal display element, it can be considered to solve such problems by using a black mask (hereinbelow, referred to as BM). BM is arranged at an interline portion of electrodes of a display side substrate so that the interline portion is always in black without suffering any influence by an alignment state of liquid crystal.

However, this method requires a highly precise technique in aligning the position of BM and electrodes. Further, reduction in the aperture ratio will cause, reduction in the brightness of reflected light. Further, an additional process is required for forming BM whereby productivity decreases and production cost increases.

The present invention is to provide a liquid crystal display element having excellent function without changing largely the conventional manufacturing method and a liquid crystal display apparatus using the same.

### SUMMARY OF THE INVENTION

In a first aspect of the present invention, there is provided a liquid crystal display element comprising a front side substrate having a front side electrode, a rear side substrate having a rear side electrode and a liquid crystal layer interposed therebetween wherein the liquid crystal layer exhibits a plurality of display states; a display state is changed by a voltage applied across the electrodes, and at least one state among the display states is maintained stably, the liquid crystal display element being characterized in that at least a part of the front side electrode and the front side substrate is transparent; the front side electrode or the rear side electrode is divided into a plurality of electrode regions on its substrate surface, and the maximum space a (μm) between adjacent electrode regions and the thickness d (μm) of the liquid crystal layer satisfy a relational formula of 1.0·d≦a≦4.0·d.

Further, in a second aspect of the present invention, there is provided a liquid crystal display element comprising a front side substrate having a front side electrode, a rear side substrate having a rear side electrode and a liquid crystal layer interposed therebetween wherein the liquid crystal layer exhibits a plurality of display states; a display state is changed by a voltage applied across the electrodes, and at least one state among the display states is maintained stably, the liquid crystal display element being characterized in that at least a part of the front side electrode and the front side substrate is transparent; the front side electrode or the rear side electrode is divided into a plurality of electrode regions on its substrate surface; a chiral nematic liquid crystal is used for the liquid crystal layer; the maximum space a (μm) between adjacent electrode regions, the thickness d (μm) of the liquid crystal layer, and the maximum effective voltage Vₘₐₓ(V) of a voltage applied to the front side electrode and the rear side electrode satisfy a relational formula of 1.0·d≦a≦d·Vₘₐₓ/10.

Further, in a third aspect of the present invention, there is provided the liquid crystal display element according to the second aspect, wherein Vₘₐₓ is 48 V or less and 2.5 μm≦d≦6.0 μm.

Further, in a fourth aspect, there is provided the liquid crystal display element according to the second aspect, wherein at least a part of the front side electrode comprises a plurality of segment electrodes, and the rear side electrode is a single common electrode arranged so as to correspond to all the segment electrodes, or the rear side electrode is a plurality of common electrodes arranged so as to correspond to each plurality of segment electrodes.

Further in a fifth aspect, there is provided the liquid crystal display element according to the second aspect, wherein at least a part of the front side electrode is stripe-like electrodes and at least a part of the rear electrode is stripe-like electrodes, said stripe-like electrodes of the front side electrode and the rear side electrode being arranged so as to be crossed in the substrate plane.

Further, in a sixth aspect, there is provided the liquid crystal display element according to the fifth aspect, wherein the disposition density L_{d} (number/mm) of the stripe-like electrodes is 2≦L_{d}≦15.

Further, in a seventh aspect, there is provided the liquid crystal display element according to the fourth aspect, wherein the rear side electrode is a reflective electrode.

Further, in an eighth aspect, there is provided the liquid crystal display element according to the fifth aspect wherein the rear side electrode is a reflective electrode.

Further, in a ninth aspect, there is provided the liquid crystal display element according to the second aspect wherein a voltage pulse having a pulse width T (ms) of 10 ms≦T≦1000 is applied to the liquid crystal layer.

Further in a tenth aspect, there is provided a liquid crystal display apparatus characterized in that the liquid crystal display element described in the second aspect is used; a segment display and/or a dot matrix display is carried out, and figures and characters are displayed.

Further, in an eleventh aspect, there is provided the liquid crystal display apparatus according to the tenth aspect, which is used for a public display apparatus.

Further, in a twelfth aspect, there is provided the liquid crystal display apparatus according to the eleventh aspect, wherein a price of an article and/or time is displayed.

In a thirteenth aspect, there is provided the liquid crystal display apparatus according to the tenth aspect, which is used for a display apparatus for a vehicle.

In a fourteenth aspect, there is provided the liquid crystal display apparatus according to the thirteenth aspect, wherein a speed of a vehicle and/or time is displayed.

In a fifteenth aspect, there is provided a liquid crystal display element comprising a front side substrate having a front side electrode, a rear side substrate having a rear side electrode and a liquid crystal layer interposed therebetween wherein the liquid crystal layer exhibits a plurality of display states; a display state is changed by a voltage applied across the electrodes, and at least one state among the display states is maintained stably, the liquid crystal display element being characterized in that at least a part of the front side electrode and the front side substrate is transparent; the front side electrode or the rear side electrode is divided into a plurality of electrode regions on its substrate surface; an antiferroelectric liquid crystal is used for the liquid crystal layer, and the maximum space a (μm) between adjacent electrode regions, the thickness d (μm) of the liquid crystal layer, and the maximum voltage Vₒₚ (V) of a voltage applied to the front side electrode and the rear side electrode satisfy a relational formula of 1.0·d≦a≦d·Vₒₚ/40.

In a sixteenth aspect, there is provided the liquid crystal display element according to the fifteenth aspect, wherein Vₒₚ is 120 V or less and 0.5 μm≦d≦6.0 μm.

Further, in a seventeenth aspect, there is provided the liquid crystal display element according to the fifteenth aspect, wherein at least a part of the front side electrode comprises a plurality of segment electrodes, and the rear side electrode is a common electrode arranged so as to correspond to all the segment electrodes, or the rear side electrode is common electrode arranged so as to correspond to each plurality of segment electrodes.

Further, in an eighteenth aspect, there is provided the liquid crystal display element according to the fifteenth aspect, wherein at least a part of the front side electrode is stripe-like electrodes and at least a part of the rear electrode is stripe-like electrodes, said stripe-like electrodes of the front side electrode and the rear side electrode being arranged so as to be crossed in the substrate plane to effect a dot matrix display.

Further, in a nineteenth aspect, there is provided the liquid crystal display element according to the seventeenth aspect, wherein the rear side electrode is a reflective electrode.

Further, in a twentieth aspect, there is provided the liquid crystal display element according to the eighteenth aspect, wherein the rear side electrode is a reflective electrode.

Further, in a twenty-first aspect, there is provided a liquid crystal display apparatus wherein the liquid crystal display element described in the fifteenth aspect is used for a display apparatus of a vehicle.

### BRIEF DESCRIPTION OF THE DRAWINGS

FIG. 1 is a diagrammatical cross-sectional view of a chiral nematic liquid crystal display element according to the present invention.

FIG. 2 is a partly enlarged plan view showing a crossing pattern of row electrodes and column electrodes in an embodiment of the chiral nematic liquid crystal display element according to the present invention.

FIG. 3 is a diagrammatical cross-sectional view showing a relation of each part.

FIG. 4 is a plan view showing a pattern of segment electrodes according to a second embodiment.

FIG. 5 is a diagrammatical plan view showing a display state by segments in a prior art.

FIG. 6 is a diagrammatical cross-sectional view of AF-LCD of the present invention.

FIG. 7 is a graph showing the relation between a relation of an applied electric field to intensity of transmitting light and three states in the layer of AF-LCD.

FIG. 8 is a diagram showing an example that the liquid crystal display apparatus according to the present invention is used for an interior display apparatus for a vehicle.

FIG. 9 is a diagram showing an example that the liquid crystal display apparatus according to the present invention is used as an informational display apparatus.

FIG. 10 is a diagram showing an example that the liquid crystal display apparatus according to the present invention is used for a display apparatus indicating a price of an article.

### DESCRIPTION OF THE PREFERRED EMBODIMENTS

In the present invention, a uniform aligning state can be obtained in both liquid crystal regions of a pixel portion and an interline portion. In particular, reduction in the contrast ratio can be avoided in a dot matrix display. Further, in a segment display, it is possible to prevent erroneous observation to a display caused when the fringe of a pixel (an interline portion) becomes a reflective state.

According to a preferred embodiment of the present invention, a cholesteric liquid crystal or a chiral nematic liquid crystal is used for the liquid crystal layer of CL-LCD, and an antiferroelectric liquid crystal is used for the liquid crystal layer of AF-LCD.

Although the present invention can be applied to a non-full dot display such as a segment display, a further large effect is provided in a case of a dot matrix display having many interline portions in a specified surface area. For example, it is useful in a middle to large size such as a 100×400 or 200×600 dot size. Or, a sufficient visibility of display can be maintained when a fine electrode pattern is formed to be L_{d}≧6 to conduct a highly precise display.

Here, definition is made so that an electrode portion wherein electrodes are arranged to oppose between a first substrate and a second substrate (a crossing portion) is referred to as a pixel portion, and a space between adjacent electrodes on the same substrate surfaces is referred to as an interline portion. In a pixel portion, the orientation of liquid crystal is mainly controlled by an electric field produced between the opposing electrodes.

In the interline portion, on the other hand, there is no electrode at a side of at least one substrate. Accordingly, it is considered that the orientation of the liquid crystal is influenced by various causes. For example, there are a leakage electric field due to a distortion of an equipotential surface at an edge portion of an electrode, an alignment state of liquid crystal in a pixel portion determined by an electric field, an alignment controlling force at the substrate interface and so on.

Further, in conducting line successive selection driving, a difference of electric potential is caused between adjacent transparent electrodes. A large distortion is caused in an equipotential surface in either spaces among 4 electrodes adjacent to each other on the first substrate and the second substrate. Such distortion of an equipotential surface will cause a change in the orientation of liquid crystal in the interline portion.

Accordingly, in order to control the alignment state of liquid crystal by an electric field in both the pixel portion and the interline portion, it is necessary that the maximum space a between adjacent electrode regions on the same substrate surface and the thickness d (which is substantially equal to the cell gap of a liquid crystal panel. Hereinbelow, referred to as a layer thickness d.) of the liquid crystal layer satisfy a relational formula of 1.0·d≦a≦4.0·d.

In a chiral nematic liquid crystal display element, it is necessary to satisfy a relational formula of 1.0·d≦a≦d·V_{MAX}/10. Further, in a antiferroelectric liquid crystal display element, it is necessary to satisfy a relational formula of 1.0·d≦a≦d·V_{OP}/40.

In the following, description will be made as to a case that a display is conducted by driving a chiral nematic liquid crystal. As the pulse width of a voltage applied to selected pixels, a voltage to be supplied from a generally usable driver device is supposed. Namely, in a static driving system, a voltage pulse having a pulse width of 1000 ms or less and a maximum effective voltage of 48 V_{MAX} or less is applied. In a case of conducting a line successive selection driving for a dot matrix display, a selection time for one column is 100 ms or less at room temperature.

In this case, if a>d·V_{MAX}/10, it is very difficult to change the alignment state of liquid crystal in the interline portion. It is because when the maximum space a is relatively large with respect to the layer thickness d under specified driving conditions, an electric field acting on the liquid crystal in the interline portion becomes weak.

In conducting a dot matrix display, in particular, the liquid crystal region applied with an external force changes to a reflective state (PL state), and therefore, the brightness of the background in a case of providing a background color in a FC state, increases, and the contrast ratio of display decreases. Further, in conducting a segment display, a portion which should not be observed is fringed so that a state to be observed is provided, whereby there is a tendency that it is difficult to observe a display to be intended.

However, even when the above-mentioned relational formulas are not satisfied, the alignment state of liquid crystal in the interline portion can be restored by applying a high voltage for a long time. For example, even in a case that the layer thickness d is 4 μm and the maximum space a is 30 μm, the alignment state of liquid crystal in the interline portion can be restored by applying a voltage of 60 V for 10 sec so as to follow the alignment state (PL state) of the pixel portion.

However, it is difficult to drive CL-LCD with such high voltage. Further, a time for obtaining a desired display on a liquid crystal panel becomes extremely long, and the basic function required for the display element may not be achieved.

On the contrary, when the maximum space a in adjacent electrode regions is 4.0 μm or less, it is difficult to conduct a patterning treatment of a transparent electrode such as ITO. The possibility of causing short-circuiting between electrodes becomes high. Further, the possibility of causing short-circuiting in the display surface becomes high due to the invasion of contaminant between adjacent electrodes.

For such reasons, construction is made so as to satisfy the above-mentioned relational formulas in the present invention. Further, in consideration of the driving with a driving means such as a widely used driver IC or the like, it is preferable to satisfy 2.5 μm≦d≦6.0 μm, and the maximum effective voltage V_{MAX}≦48V in a case of CL-LCD. Further, it is preferable that V_{OP} is 120 V or less, and 0.5 μm≦d≦6.0 μm in a case of AF-LCD.

Next, the structure of the liquid crystal display element of the present invention will be described. In FIG. 1, a liquid crystal display element 1 comprises a first substrate 2 and a second substrate 3. Glass or a plastic material is used for the substrates, and ITO is used for electrodes.

In Example 1 described later, a full dot matrix display is conducted. On the first substrate 2, a plurality of row electrodes 21 are arranged in a stripe-like form in parallel with predetermined intervals (with an interline width). On the second substrate 3, a plurality of column electrodes 31 are arranged in a stripe form in parallel with predetermined intervals. Interline widths of the row electrodes 21 and the column electrodes 31 were made equal. In a case that the stripe-like electrodes are arranged in parallel, the maximum space a is equal to the interline width.

In the present invention, the maximum space a corresponds to an effective length capable of giving influence to the generation of an electric field in adjacent electrode regions. In a curve portion of electrodes, an effective interline width should be supposed. Further, in a case that the space between electrodes gradually changes, an interline distance which is effective and provides the maximum value should be used.

In Example 2, a segment display is conducted. On the first substrate 2, an overall surface electrode 21 is formed, and on the second substrate 3, electrodes 31 corresponding to display pixels and electrodes 31 corresponding to a background portion are formed.

On electrode shaping surfaces of the first substrate 2 and the second substrate 3, an electric insulating layer and an alignment layer are formed respectively (figures omitted). Further, a color filter may be formed at an inner surface side of at least one substrate in order to adjust visibility. The first substrate 2 and the second substrate 3 are press-bonded by interposing a peripheral sealing material 4, and a liquid crystal layer 5 is filled between the substrates. Depending on a positional relation between the electrodes and the liquid crystal, an interline portion A, an interline width a, a pixel portion D, a display pixel electrode D1 and a background pixel electrode D2 are provided (reference to FIGS. 1, 3 and 4).

In Examples 1 and 2, a terminal portion 3a is provided in contiguity with the second substrate 3, and drawing electrodes 32 are formed at the terminal portion 3a. The column electrodes 31 on the second substrate 3 are connected directly to predetermined electrodes in the drawing electrodes 32. The row electrode 21 on the first substrate 2 is in an electrically conductive state to predetermined electrodes in the drawing electrodes 32 by means of a transfer material such as electric conductive beads containing in the peripheral sealing material 4. Drawing electrodes may be formed on the first substrate and the second substrate respectively without using the transfer material.

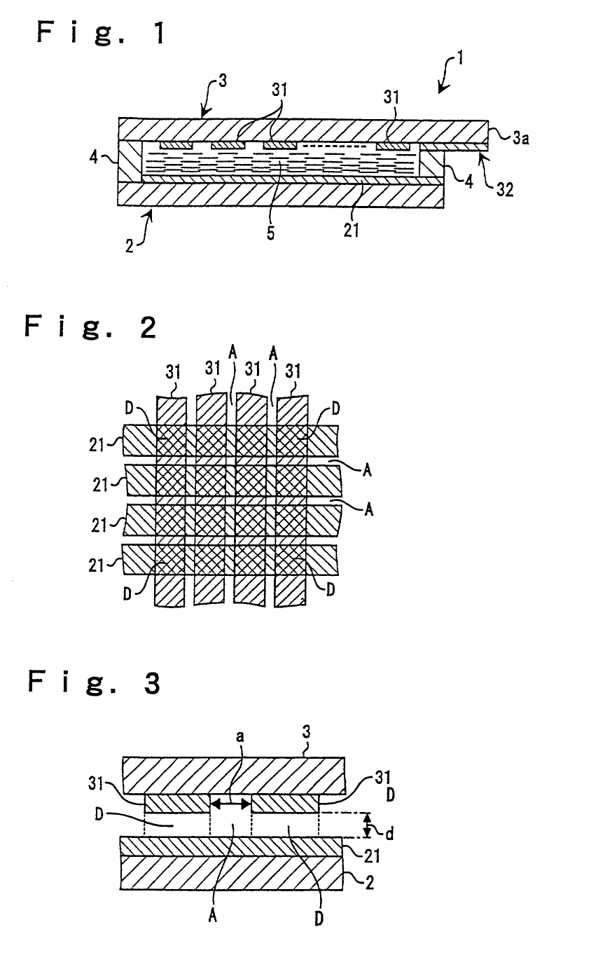

As shown in FIGS. 2 and 3, each crossing portion D of the opposed row electrodes 21 and the column electrodes 31 constitutes a pixel. An interline portion is a region indicated by reference mark A. Thus, spaces between adjacent row electrodes 21, 21 and spaces between adjacent column electrodes 31, 31 are interline portions A.

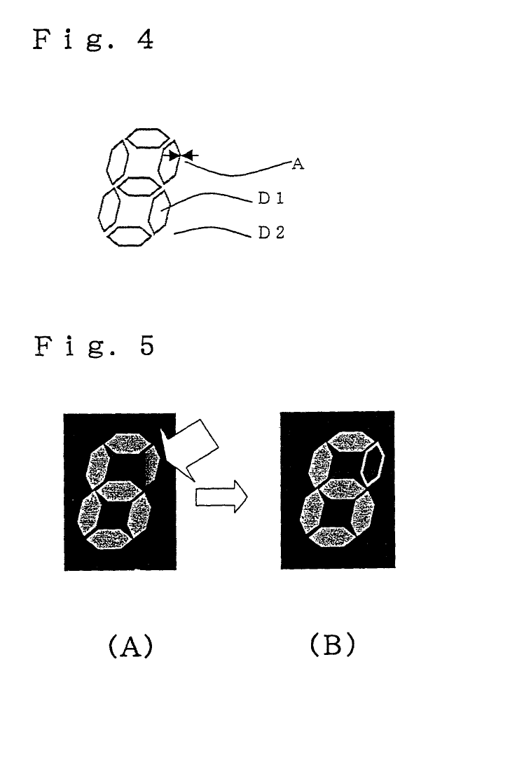

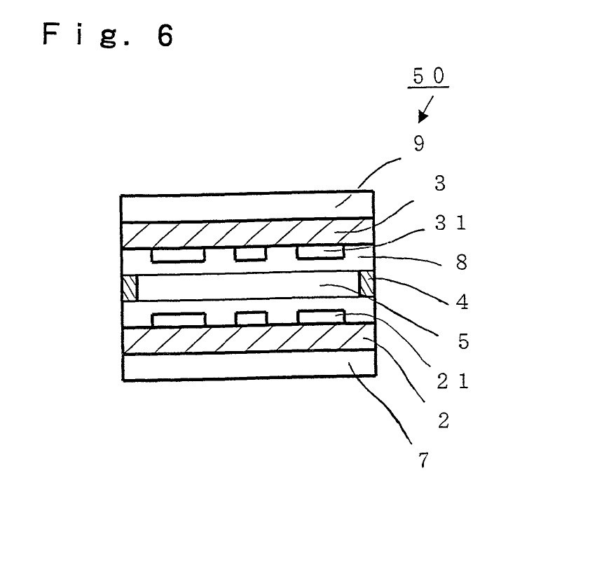

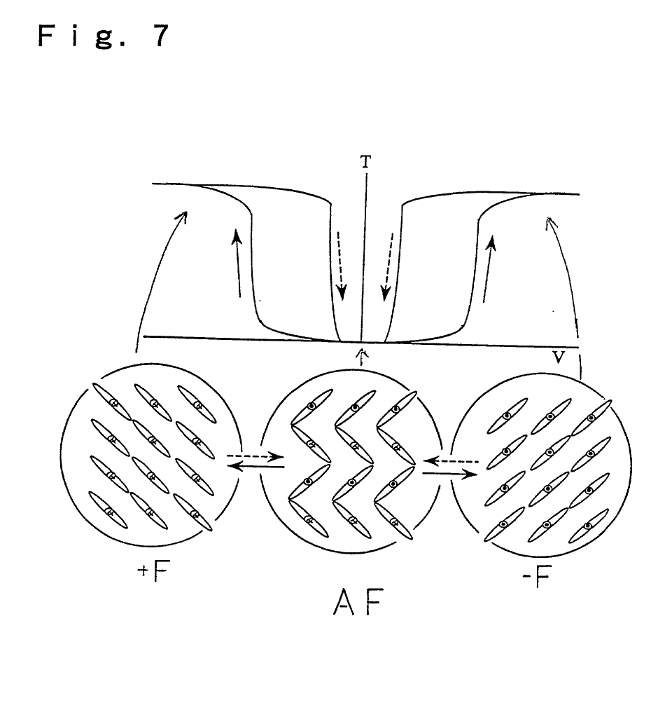

In FIG. 4, a symbol D1 designates an electrode portion corresponding to a display segment, and a symbol D2 designates an electrode located in the background portion. Here, attention should be paid to the layer thickness d (μm) in a pixel portion and the width of an interline potion A (an interline width). Namely, when the maximum space between adjacent row electrodes 21 or between adjacent column electrodes 31 is represented by a (μm), the construction is made so as to satisfy a relational formula of 1.0·d≦a≦4.0·d in the present invention.

In a case of a chiral nematic liquid crystal, 1.0·d≦a≦d·V_{MAX}/10 should be satisfied. It is further preferable that relational formulas of 4.0 μm≦a and 2.5 μm≦d≦6.0 μm, and the maximum effective voltage V_{MAX}≦48V should be satisfied simultaneously.

With such construction, it is possible to apply an electric field having a sufficient intensity to change the alignment state of the liquid crystal in an interline portion A from the electrodes located at a pixel portion. The present invention is applicable not only to a full dot display type liquid crystal display element but also a segment display type or a dot character display type liquid crystal display element.

### EXAMPLE 1

Two substrates with a transparent electric conductive layers made of ITO were prepared. Etching was conducted to provide the maximum space a of 10 μm, and 160 stripe electrodes were arranged on each substrate. After an electric insulating layer was formed on each substrate at a side where the electrodes were formed, a solution of polyimide resin was coated and baked to thereby form an alignment layer. The substrates were used as they are without conducting rubbing to a front surface of the alignment layer.

A cell was prepared by arranging the two substrates so that their stripe electrodes crossed perpendicularly: scattering spacers having a diameter of 4 μm on the opposing surfaces: coating a peripheral sealing material composed of an epoxy resin containing a slight amount of glass fibers having a diameter of 4 μm at 4 sides of the substrates excluding a portion corresponding to a liquid crystal introducing port, and by bonding the two substrates.

Then, a chiral nematic liquid crystal composition was formulated by mixing 66.5 parts of a nematic liquid crystal (T_{c}=97° C., Δn=0.242 and Δε=13.8), 16.75 parts of an optically active compound according to the below-mentioned chemical formula 1 and 16.75 parts of an optically active compound according to the below-mentioned chemical formula 2, both being a chiral agent.

The pitch can be adjusted depending on a kind of liquid crystal material, a kind of chiral agent and a mixing ratio of the both. Then, a liquid crystal panel was formed by introducing the chiral nematic liquid crystal composition into the liquid crystal cell by using a vacuum injection method and sealing the injection port by a photo-curable resin.

[chemical structure]

The substrate surface at a rear side of the liquid crystal panel was coated with a lusterless black paint, and a tape of copper foil with an electric-conductive adhesive was attached to an electrode drawing portion (a terminal portion) to short-circuit the stripe electrodes.

In the thus formed CL-LCD, the direction in average of the alignment axes (helical axes) in a twisted structure having a constant repetitive period (pitch) directs in a substantially perpendicular direction to the substrates with electrodes in a PL state. A selective reflection is caused by a specified wavelength λ determined by a pitch p and an average refractive index n_{AVG} of liquid crystal (λ=n_{AVG}·p).

On the other hand, in a FC state, the helical axes direct in random directions with respect to the substrates with electrodes whereby the almost part of incident light passes through although a part of the light is scattered. Accordingly, the color of a colored layer provided at a rear side is observed from a front side.

A bipolar rectangular wave pulse having a pulse width of 500 ms and 30V was applied as the maximum effective voltage V_{MAX}, to the electrode drawing portion of the liquid crystal panel. As a result, pixel portions were all turned to be a PL state and a green light was reflected.

Then, a bipolar rectangular wave pulse of 20 V was applied. A weak scattering state was exhibited in a FC state; a black tone as a background color was observed from a front side, and pixel portions were all turned to be a black color. The contrast ratio determined by the total reflectance of a green color in a PL state and the total reflectance of a black color in a FC state was 10.

Next, the liquid crystal panel was pressed by a finger in a perpendicular direction with respect to its substrate surface. Then, the pressed portion turned to be a PL state (a reflective state) including the interline portion. A bipolar rectangular wave pulse having an effective value of 30 V was applied again. As a result, all the pixel portions and the interline portions turned entirely to be a reflective state.

Further, in applying a bipolar rectangular wave pulse of an effective value of 20 V, a display including interline portions turned entirely to black. The contrast ratio dividing the reflectance at the time of reflection by the reflectance of black at this moment was 10, and no change was observed. Accordingly, the contents of a display changed by an external force could be reproduced by rewriting without reducing the contrast ratio. In this Example, since the layer thickness d was 4 μm, d·V_{MAX}/10=12, and the condition of 10 μm or more with respect to the relation of the maximum space a of stripe electrodes could be satisfied.

In this Example, since a display state was changed by applying only once a voltage pulse, it was necessary to apply a long pulse width of about 500 ms. When the liquid crystal panel is used around room temperature while an excellent contrast ratio (≧5) is maintained, it can be driven with a pulse width of 200 ms≦T≦600 ms. When it is driven in a relatively wide temperature range of 0-70° C. at a smaller number of times of application, a pulse width of 500 ms≦T≦1000 ms should be used.

Further, in a multiplex driving, it is substantially equal in effect to a case that a static voltage pulse is applied 2-3 times. Accordingly, driving can be conducted with a pulse width in a range of 10 ms≦T≦50 ms. Conditions to a required contrast ratio are different depending on purposes of use of the liquid crystal display element. Accordingly, when conditions are relaxed (for example, contrast ratio ≧3), the voltage of the above-mentioned voltage pulse can be determined to a lower value, or the above-mentioned pulse width can be determined to a shorter value.

Further, the method for changing the state of CL-LCD by applying a voltage, in particular, the driving method for resetting into a FC state via three stages, is described in Japanese Patent Application No. 2000-118942, and the present invention includes the contents of the application.

### EXAMPLE 2

Two substrates with a transparent electric-conductive film made of ITO were prepared, and an overall surface electrode was formed on one of the substrates (hereinbelow, referred to as a R plate). On the other substrate (hereinbelow, referred to as a F plate), 7 segments electrodes D1 capable of displaying figures of 0-9 by on-off operations independently and a background electrode D2 corresponding to a background portion were formed (FIG. 4).

The maximum space a between the segment electrodes and the background electrode was 12 μm, and an electrode pattern was formed by etching. After an electric insulating layer was formed on each of the substrates at a surface side where the electrodes were formed, a solution of polyimide resin was coated and baked to prepare an alignment layer. The surface of the alignment layer was left in a non-alignment state in the same manner as in Example 1.

A liquid crystal cell was prepared by opposing these two substrates, scattering spacers having a diameter of 4 μm on the opposing surfaces, coating a peripheral sealing material comprising an epoxy resin containing a slight amount of glass fibers having a diameter of 4 μm at 4 sides of the substrates excluding a portion where an liquid crystal injection port was formed, and bonding these two substrates.

Then, a chiral nematic liquid crystal composition comprising 66.5 parts of a nematic liquid crystal (T_{c}=97° C., Δn=0.242 and Δε=13.8), 16.75 parts of an optically active compound according to the above-mentioned chemical formula 1 and 16.75 parts of an optically active compound according to the above-mentioned chemical formula 2 was formulated. A liquid crystal panel was formed by injecting the composition into the liquid crystal cell by a vacuum injection method, and sealing the injection port by a photo-curing resin.

The surface of one of the substrates of the liquid crystal panel was coated with a lusterless black paint. An electrode drawing portion (a terminal portion) corresponding to a background portion was selected among the electrode drawing portion of the F plate, and a bipolar rectangular wave pulse having a pulse width of 500 ms and an effective value of 20V was applied across the selected electrode drawing portion and the electrode drawing portion of the R plate. As a result, the background portion was entirely turned to a black display (a FC state). Even in this Example, a single voltage pulse was applied for driving.

Then, a tape of copper foil with an electrically conductive adhesive was attached to 5 electrode drawing parts (terminal parts) corresponding to pixels for displaying “2” to make the state into a short-circuiting state, and a bipolar rectangular wave pulse having a pulse width of 500 ms and an effective value of 40V was applied across these electrode drawing parts and the electrode drawing portion of the R plate.

As a result, the above-mentioned black background portion remained unchanged, and only the pixels corresponding to a character of “2” were turned to be a light reflective state (a PL state), whereby the character of “2” was correctly displayed.

Then, a portion including a pixel portion of non-display when “2” was displayed, was pressed by a finger in a perpendicular direction with respect to the substrate surface. As a result, the pressed portion was turned to be a reflective state including the background portion and the interline portion. Then, a bipolar pulse having an effective value of 20 V was again applied to background electrodes, and subsequently, a bipolar rectangular wave pulse having an effective value of 40V was applied to the corresponding pixel electrodes. As a result, only the pixels corresponding to the character of “2” were turned to be a reflective state, and the character of “2” was correctly displayed in the black background.

As described above, the contents of the display changed by an external force could be restored to a correct display by rewriting. Since the layer thickness d in this Example was 4 μm, d·Vₘₐₓ/10=16 was provided, and the condition of 12 μm or more in a relation of the maximum space a was satisfied.

In this Example, although the overall surface electrode was used as the common electrode, a plurality of common electrodes may be provided so as to each figure of 7 segments as a unit.

### COMPARATIVE EXAMPLE 1

A liquid crystal cell was prepared in the same manners in Example 1 except that the maximum space a in each of the substrates was 30 μm and 160 stripe electrodes are arranged in parallel. Since the layer thickness d was 4 μm, the maximum space a of the stripe electrodes was 7.5 times of the layer thickness d. A liquid crystal panel was formed by injecting the same chiral nematic liquid crystal composition as in Example 1 into the liquid crystal cell and sealing the injection port.

In this liquid crystal panel too, a lusterless black paint was coated on the surface of one substrate in the same manner as Example 1. Further, a tape of copper foil with an electrically conductive adhesive was attached to the electrode drawing portion to make the stripe electrodes into a short-circuiting state.

Then, a bipolar rectangular wave pulse having a pulse width of 500 ms and an effective value of 30 V was applied in the same manner as in Example 1. The pixel portion was entirely turned to be a reflective state (a PL state).

Then, a bipolar rectangular wave pulse having an effective value of 20 V was applied in the same manner as in Example 1. Then, the pixel portion was entirely turned to be black (a FC state). The contrast ratio by dividing the total reflectance at the time of the previous reflection by the total reflectance of black was

The liquid crystal panel was pressed by a finger in a perpendicular direction with respect to the substrate surface in the same manner as in Example 1. The pressed portion including the interline portion was turned to be a reflective state. Then, a bipolar rectangular wave pulse having an effective value of 30 V was again applied. The pixel portion was turned to be a reflective state in the overall surface. However, there was no change in the interline portion, and a reflective state was provided in the entire surface in this Comparative Example 1.

Further, when a bipolar rectangular wave pulse having an effective value of 20 V was applied, the pixel portion was turned to be black, however, the interline portion remained in a reflective state. The contrast ratio by dividing the reflectance after the application of the pulse of 30V by the reflectance of black at this time was 4. When the contents of the display changed by the application of an external force was reproduced by rewriting, the contrast ratio decreased largely.

### EXAMPLE 3

AF-LCD can be formed as described below. An ITO electrode having a parallel pattern of a pitch of 350 μm and an interline of 2 μm is formed on a pair of substrates. A low pretilt alignment layer is formed in a thickness of about 300 Å on the substrate surfaces by a transfer printing method, and rubbing is conducted to the alignment layers of the substrates in mutually opposite directions by using a rubbing cloth made of cotton (manufactured by Hiroki Co., Ltd.) A sealing material is provided at the periphery of the substrates, and a cell provided with an injection port is formed so that the cell gap in a display portion is about 1.5 μm.

An antiferroelectric liquid crystal is injected under vacuum heating condition and the injection port is sealed. A polarizer is attached to a rear side substrate so that the polarization axis is in parallel to a direction of rubbing, and a polarizer is attached to a front side substrate so that the polarization axis crosses at a right angle to the polarization axis of the rear side.

A current feeding treatment is conducted by applying to the liquid crystal cell a rectangular wave of 100 V_{PP} as V_{OP}. The current feeding treatment is conducted not only to the pixel portion but also the interline portion so that the orientation of liquid crystal is uniform. With this, a uniform aligning treatment can be achieved to the entire display surface of a liquid crystal display element, and desired displaying functions can be provided.

### EXAMPLE 4

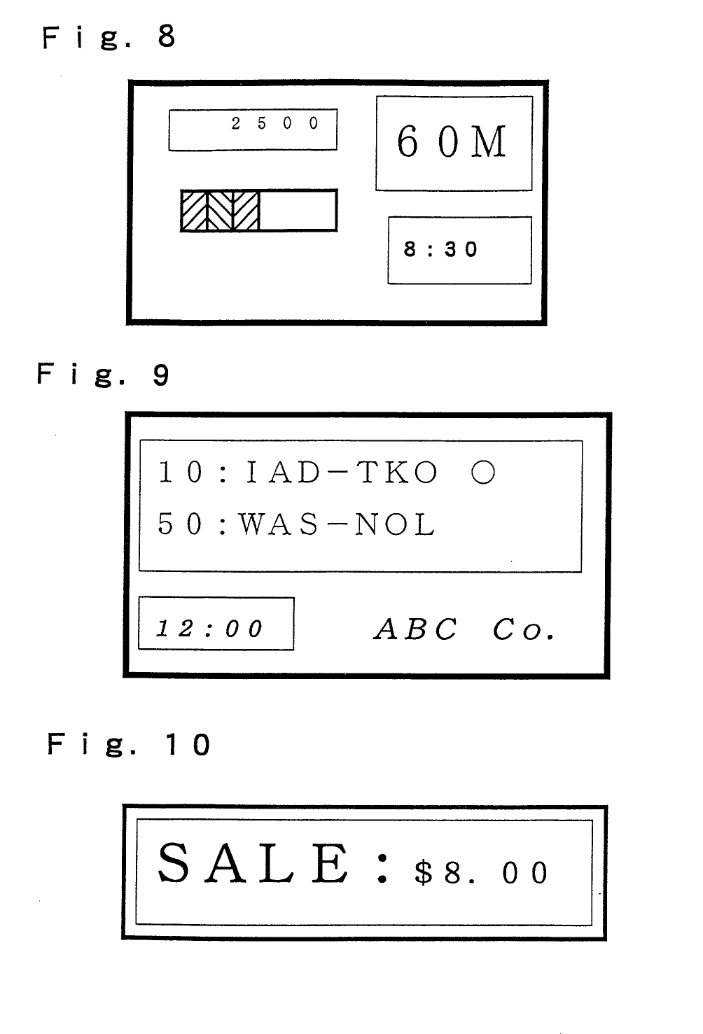

A liquid crystal display apparatus for public use can be prepared by using the above-mentioned liquid crystal display element. The apparatus is for displaying gauges in a vehicle. Since a high-speed display and a very wide viewing angle are required, it is preferable to use AF-LCD. A driving speed of the vehicle, an accumulated mileage, a charged amount of the battery and time can simultaneously be displayed. FIG. 8 shows diagrammatically an example of a display state. Even though there is a partial distortion in the alignment of the liquid crystal display surface in case of incorporation of liquid crystal display apparatus or due to an external factor, the apparatus can have function to restore into a normal display state.

### EXAMPLE 5

By using the above-mentioned CL-LCD, a guiding display apparatus in an air port or a terminal station can be fabricated. Flight numbers of airplane, names of the place of departure or arrival, time and names of advertising companies can simultaneously be displayed. Since a display state can be maintained even when the power source is interrupted for a predetermined time, energy can be saved. Further, when rewriting of a displayed information is required, the display can instantaneously be renewed. FIG. 9 shows diagrammatically an example of a display state. Although there is a possibility that an external force is applied to a display surface depending on environments of use, the apparatus has functions to restore into a normal display by rewriting.

### EXAMPLE 6

A display apparatus for displaying a price of an article can be fabricated by using the above-mentioned CL-LCD. Information of how to handling and a price of an article can be displayed. Since a display state can be maintained even when a power source is interrupted for a predetermined time, energy can be saved. Further, when rewriting of a displayed information is required, the display can instantaneously renewed. FIG. 10 shows diagrammatically an example of a display state. Although there is a possibility that an external force is applied to the display surface depending on environments of use, it has functions to restore into a normal display by rewriting.

As described above, according to the present invention, a liquid crystal display element comprising a liquid crystal layer having a memory function is constructed so that the maximum space a of adjacent electrodes on the same substrate surface and the layer thickness d satisfy 1.0·d≦a≦4.0·d. Accordingly, the element can provide a stable operation continuously in environments of use in addition to realizing the basic operations.

In the liquid crystal display element, the contents of a display can be restored without reducing the contrast ratio by conducting rewriting even when the display is changed due to an external factor, or erroneous observation of display in a non-display portion can be prevented.

What is claimed as new and is desired to be secured by Letters of the United States is:

1. In a liquid crystal display element comprising a front side substrate having a front side electrode, a rear side substrate having a rear side electrode and a liquid crystal layer interposed therebetween wherein the liquid crystal layer exhibits a plurality of display states; a display state is changed by a voltage applied across the electrodes, and at least one state among the display states is maintained stably, the liquid crystal display element being characterized in that at least a part of the front side electrode and the front side substrate is transparent; the front side electrode or the rear side electrode is divided into a plurality of electrode regions on its substrate surface, and the maximum space a (μm) between adjacent electrode regions and the thickness d (μm) of the liquid crystal layer satisfy a relational formula of 1.0·d≦a≦4.0·d.

2. In a liquid crystal display element comprising a front side substrate having a front side electrode, a rear side substrate having a rear side electrode and a liquid crystal layer interposed therebetween wherein the liquid crystal layer exhibits a plurality of display states; a display state is changed by a voltage applied across the electrodes, and at least one state among the display states is maintained stably, the liquid crystal display element being characterized in that at least a part of the front side electrode and the front side substrate is transparent; the front side electrode or the rear side electrode is divided into a plurality of electrode regions on its substrate surface; a chiral nematic liquid crystal is used for the liquid crystal layer; the maximum space a (μm) between adjacent electrode regions, the thickness d (μm) of the liquid crystal layer, and the maximum effective voltage Vₘₐₓ(V) of a voltage applied to the front side electrode and the rear side electrode satisfy a relational formula of 1.0·d≦a≦d·Vₘₐₓ/10.

3. The liquid crystal display element according to claim 2, wherein Vₘₐₓ is 48 V or less and 2.5 μm≦d≦6.0 μm.

4. The liquid crystal display element according to claim 2, wherein at least a part of the front side electrode comprises a plurality of segment electrodes, and the rear side electrode is a single common electrode arranged so as to correspond to all the segment electrodes, or the rear side electrode is a plurality of common electrodes arranged so as to correspond to each plurality of segment electrodes.

5. The liquid crystal display element according to claim 2, wherein at least a part of the front side electrode is stripe-like electrodes and at least a part of the rear electrode is stripe-like electrodes, said stripe-like electrodes of the front side electrode and the rear side electrode being arranged so as to be crossed in the substrate plane.

6. The liquid crystal display element according to claim 5, wherein the disposition density L_{d} (number/mm) of the stripe-like electrodes is 2≦L_{d}≦15.

7. The liquid crystal display element according to claim 4, wherein the rear side electrode is a reflective electrode.

8. The liquid crystal display element according to claim 5 wherein the rear side electrode is a reflective electrode.

9. The liquid crystal display element according to claim 2 wherein a voltage pulse having a pulse width T (ms) of 10 ms≦T≦1000 is applied to the liquid crystal layer.

10. A liquid crystal display apparatus characterized in that the liquid crystal display element described in claim 2 is used; a segment display and/or a dot matrix display is carried out, and figures and characters are displayed.

11. The liquid crystal display apparatus according to claim 10, which is used for a public display apparatus.

12. The liquid crystal display apparatus according to claim 11, wherein a price of an article and/or time is displayed.

13. The liquid crystal display apparatus according to claim 10, which is used for a display apparatus for a vehicle.

14. The liquid crystal display apparatus according to claim 13, wherein a speed of a vehicle and/or time is displayed.

15. In a liquid crystal display element comprising a front side substrate having a front side electrode, a rear side substrate having a rear side electrode and a liquid crystal layer interposed therebetween wherein the liquid crystal layer exhibits a plurality of display states; a display state is changed by a voltage applied across the electrodes, and at least one state among the display states is maintained stably, the liquid crystal display element being characterized in that at least a part of the front side electrode and the front side substrate is transparent; the front side electrode or the rear side electrode is divided into a plurality of electrode regions on its substrate surface; an antiferroelectric liquid crystal is used for the liquid crystal layer, and the maximum space a (μm) between adjacent electrode regions, the thickness d (μm) of the liquid crystal layer, and the maximum voltage V_{OP} (V) of a voltage applied to the front side electrode and the rear side electrode satisfy a relational formula of 1.0·d≦a≦d·V_{OP}/40.

16. The liquid crystal display element according to claim 15, wherein V_{OP} is 120 V or less and 0.5 μm≦d≦6.0 μm.

17. The liquid crystal display element according to claim 15, wherein at least a part of the front side electrode comprises a plurality of segment electrodes, and the rear side electrode is a common electrode arranged so as to correspond to all the segment electrodes, or the rear side electrode is a common electrode arranged so as to correspond to each plurality of segment electrodes.

18. The liquid crystal display element according to claim 15, wherein at least a part of the front side electrode is stripe-like electrodes and at least a part of the rear electrode is stripe-like electrodes, said stripe-like electrodes of the front side electrode and the rear side electrode being arranged so as to be crossed in the substrate plane to effect a dot matrix display.

19. The liquid crystal display element according to claim 17, wherein the rear side electrode is a reflective electrode.

20. The liquid crystal display element according to claim 18, wherein the rear side electrode is a reflective electrode.

21. A liquid crystal display apparatus wherein the liquid crystal display element described in claim 15 is used for a display apparatus of a vehicle.
